(19) United States
(12) Patent Application Publication
(10) Pub. No.: US 2009/0162678 A1
(43) Pub. Date: Jun. 25, 2009

(54) MAGNESIUM ALLOY ARTICLE AND METHOD FOR FABRICATING THE SAME

(75) Inventors: SHENG-EN HSU, Tu-Cheng (TW); YONG LIU, Shenzhen City (CN); FEI-XIANG LI, Shenzhen City (CN); ZHAO JIN, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/168,053

(22) Filed: Jul. 3, 2008

(30) Foreign Application Priority Data
Dec. 19, 2007 (CN) 200710203235.0

(51) Int. Cl. B32B 15/04; B05D 3/10

(52) U.S. Cl. 428/457; 427/327

(57) ABSTRACT

An exemplary magnesium alloy article includes a main body and a phosphate film formed on a surface of the magnesium alloy main body. The phosphate film contains carbon, oxygen, magnesium, aluminum, phosphorus, and manganese. A method for fabricating the present magnesium alloy article is also provided.

### BACKGROUND OF THE INVENTION

1. Field of the Invention

The present invention relates a magnesium alloy article and a method for fabricating the same.

2. Discussion of the Related Art

Magnesium alloy is a good candidate for use in various electronic devices and vehicles because of its high mechanical strength and light weight.

When an article of magnesium alloy is used, the article tends to corrode easily because magnesium oxidizes easily with other chemical substances such as acids. Typically, a phosphate film is formed on top of an outer surface of the article to protect the article, and a paint layer is formed over the phosphate film. The phosphate film generally consists of phosphate compounds such as Mg₃(PO₄)₂, Mn₃(PO₄)₂, and so on. However, because bonding strength between the paint layer and the phosphate film is relatively weak, the paint layer easily detaches from the phosphate film, reducing the effective lifespan of the magnesium alloy article.

A new magnesium alloy article and a method for fabricating the magnesium alloy article are thus desired in order to overcome the limitations described.

### SUMMARY

A magnesium alloy article includes a main body and a phosphate film formed on a surface thereof. The phosphate film contains carbon, oxygen, magnesium, aluminum, phosphorus, and manganese.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present magnesium alloy article. Moreover, in the drawings, like reference numerals designate corresponding parts throughout several views, and all the views are schematic.

FIG. 1 is a flowchart of a method for fabricating a magnesium alloy article in accordance with a preferred embodiment of the present invention.

FIG. 2 is a table showing parameters for the method of FIG. 1.

FIG. 3 is a table showing various acid pickling solutions, alkaline solutions, and phosphate solutions.

FIG. 4 is a table showing a test result of the samples.

### DETAILED DESCRIPTION OF THE PREFERRED EMBODIMENT

Reference will now be made to the drawings to describe preferred embodiments of the present magnesium alloy article, and method for fabricating the same, in details.

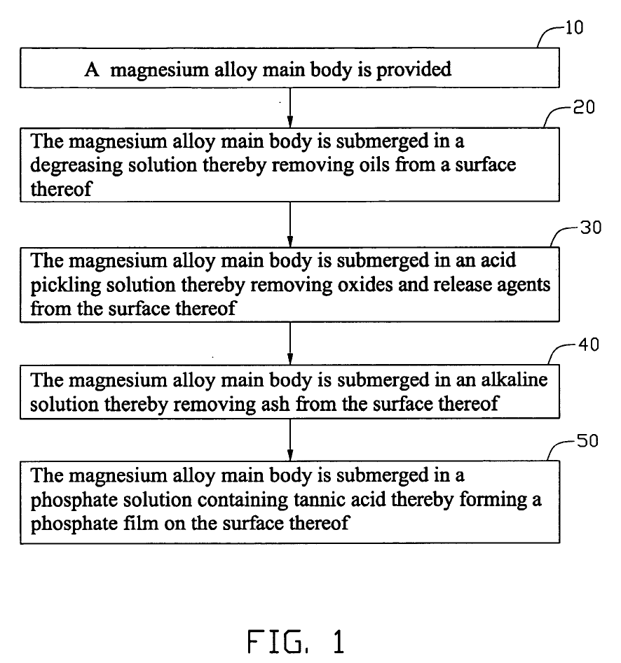

FIG. 1 is a flowchart of a method of fabricating a magnesium alloy article, the method including the following steps.

In Step 10, a magnesium alloy main body is provided, and in Step 20, is submerged in a degreasing solution to remove oils or the like from the surface thereof. In Step 30, the magnesium alloy main body is submerged in an acid pickling solution to remove oxides and release agents from the surface thereof. In Step 40, the magnesium alloy main body is submerged in an alkaline solution to remove black ash from the surface thereof. Finally, in Step 50, the magnesium alloy main body is submerged in a phosphate solution containing tannic acid to form a phosphate film on the surface thereof. A magnesium alloy article is thus yielded. The magnesium alloy article includes a main body and a phosphate film formed on the surface thereof.

Step 20, submersion of the magnesium alloy main body in the degreasing solution preferably lasts from 4 to 8 minutes, with temperature of the degreasing solution preferably from 55° C. to 65° C. The degreasing solution consists of sodium hydroxide (NaOH) or sodium phosphate (Na₃PO₄), and water (H₂O). The degreasing solution is applied to remove oils from the surface of the magnesium alloy main body. Note that, after the magnesium alloy main body has been sand blasted, oils on the surface of the magnesium alloy main body have already been removed and step 20 can be omitted.

Step 30, submersion of the magnesium alloy main body in the acid pickling solution lasts from 3 to 5 minutes, with temperature of the acid pickling solution from 35° C. to 45° C. The acid pickling solution may consist of citric acid, surface active agent, and water. The surface active agent is water soluble and silicone-free. Concentration of the citric acid is from 5 g/l to 30 g/l. Concentration of the surface active agent (industrial grade) is from 1.5 g/l to 6 g/l.

The citric acid reacts with and removes oxides and release agents from the surface of the magnesium alloy main body. The oxides mainly consist of magnesia (MgO), alumina (Al₂O₃), and zinc oxide (ZnO). The release agents include a resin represented by the formula (CH₂)ₘ—CH(Si)ₙ—COOR, wherein R represents a functional group such as the methyl group. At the same time, the citric acid may prevent black ash (mainly Al and Zn) from forming on the surface of the magnesium alloy main body. Concentration of the citric acid is from 8 g/l to 15 g/l. Upon submersion of the magnesium alloy main body in the acid pickling solution, the following chemical reactions occur:

MgO+2H⁺═Mg²⁺+H₂O;

Al₂O₃+6H⁺═2Al³⁺+3H₂O;

ZnO+2H⁺═Zn²⁺+H₂O;

Mg+2H⁺═Mg²⁺+H₂;

(CH₂)ₘ—CH(Si)ₙ—COOR+H⁺═R⁺+(CH₂)ₘ—CH(Si)ₙ—COOH.

The surface active agent acts as a buffer preventing excessive corrosion of the magnesium alloy main body. A hydrophilic group of the surface active agent is the hydroxyl group. The surface active agent can be a polyalcohol, such as poly ethylene glycol, glycerol, neopentyl glycol, sucrose, dextrose, or sorbitol. Concentration of the surface active agent is from 3 g/l to 4 g/l.

Step 40, submersion of the magnesium alloy main body in the alkaline solution takes from 3 to 5 minutes, with temperature of the alkaline solution from 60° C. to 80° C., and solute of the alkaline solution may include potassium hydroxide (KOH) or NaOH.

The alkaline solution is mainly used to react with and remove black ash from the surface of the magnesium alloy main body, such that a base of the magnesium alloy main body is exposed. When the solute is KOH (industrial grade), concentration of the KOH is from 60 g/l to 180 g/l. Preferably, concentration of the KOH is from 100 g/l to 150 g/l. Upon submersion of the magnesium alloy main body in the alkaline solution, the following chemical reactions occur:

6KOH+2Al=2K₃AlO₃+3H₂;

2KOH+Zn═K₂ZnO₂+H₂.

Step 50, submersion of the magnesium alloy main body in the phosphate solution takes from 30 to 50 seconds, with temperature of the phosphate solution from 35° C. to 45° C. Thickness of the phosphate film is from 5μ to 30μ. Electrical surface resistance of the magnesium alloy main body is less than 2 ohm. The phosphate solution consists of 2.89 g/l to 8.67 g/l of phosphoric acid (H₃PO₄) (industrial grade), 0.3 g/l to 1 g/l of carbamide ((NH₂)₂CO) (Analytical Reagent Grade), 0.39 g/l to 1.56 g/l of nitric acid (HNO₃) (industrial grade), 6 g/l to 30 g/l of manganese dihydrogen phosphate (Mn(H₂PO₄)₂) (industrial grade), and 0.2 g/l to 0.6 g/l of tannic acid (C₇₆H₅₂O₄₆) (Analytical Reagent Grade).

The H₃PO₄ provides PO₄³⁺ ions. To further regulate thickness of the phosphate film formed on the surface of the main body, concentration of the phosphoric acid solution is, preferably 4.34 g/l to 6.5 g/l.

The (NH₂)₂CO coats the phosphate film more uniformly. To prevent the phosphate film from developing (forming) too slowly, concentration of the (NH₂)₂CO is, preferably 0.4 g/l to 0.6 g/l.

The HNO₃ provides H⁺ ions to adjust a PH value of the phosphate solution to be 6.5 to about 9.5. Preferably, concentration of the HNO₃ is from 0.62 g/l to 0.94 g/l.

The Mn(H₂PO₄)₂ provides Mn²⁺, PO₄³⁺, and H⁺ ions. To further regulate (form) a more uniform coating of the phosphate film on the surface of the main body, concentration of Mn(H₂PO₄)₂ is preferably 10 g/l to 18 g/l.

The tannic acid improves bonding strength between the phosphate film and the paint layer coated on the phosphate film. Preferably, concentration of the tannic acid is from 0.4 g/l to 0.55 g/l.

The phosphate film mainly consists of phosphate compounds such as Mg₃(PO₄)₂, Mn₃(PO₄)₂, and others. Upon submersion of the magnesium alloy main body in the phosphate solution, the following chemical reactions occur;

Mg+2H⁺═Mg²⁺+H₂;

3Mg²⁺+2PO₄³⁻═Mg₃(PO₄)₂;

3Mn²⁺+2PO₄³⁻═Mn₃(PO₄)₂.

The formula of the phosphate compound is:

(Mg²⁺)_{A}(Mn²⁺)_{B}(NO³⁻)_{C}(Zn²⁺)_{D}(PO₄³⁻)_{E} . . . .

Because the phosphate solution includes tannic acid and (NH₂)₂CO, after the phosphate is formed, the carbon atoms (C), and oxygen atoms (O) contained in the tannic acid and (NH₂)₂CO enter the phosphate film, such that the phosphate film further includes elements such as carbon (C), oxygen (O), magnesium (Mg), aluminium (Al), phosphorus (P), and manganese (Mn).

It can be understood that the method can include at least one water rinse step after step 20, step 30, step 40, and step 50 and further can include a drying process after step 50, a period of placing the magnesium alloy main body in an oven from 30 to 70 minutes, with temperature of the oven from 110° C. to 150° C.

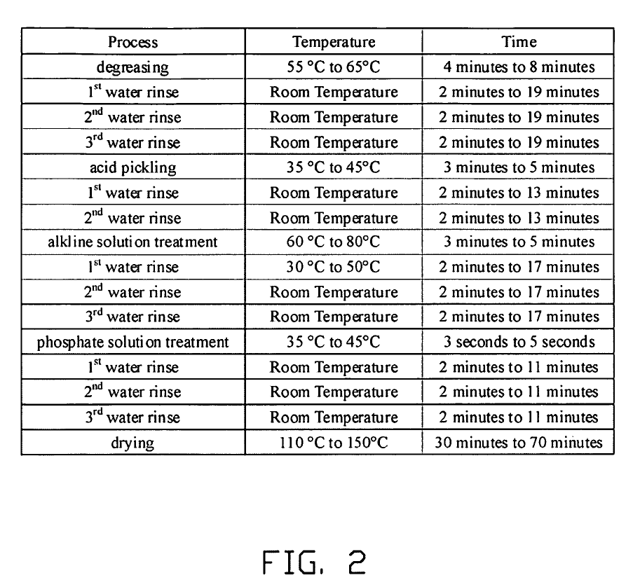

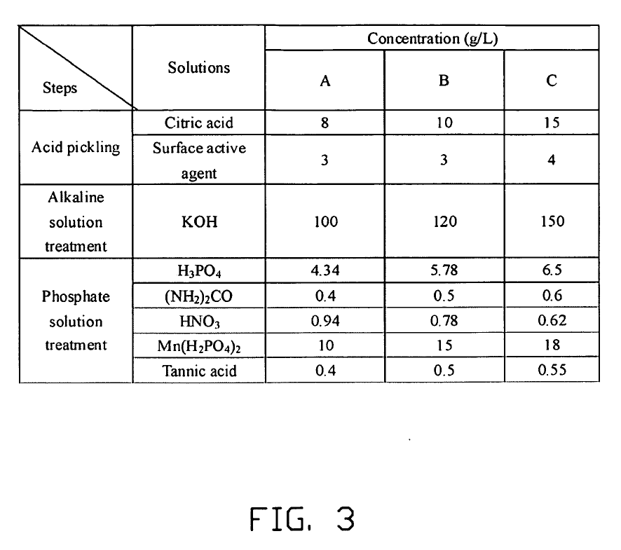

Detailed embodiments are described as follows. Three groups (1^{st} group, 2^{nd} group, and 3^{rd} group, each including three magnesium alloy main bodies) of magnesium alloy main bodies are provided. Material of each of the magnesium alloy main bodies is AZ91D. The three groups of magnesium alloy main bodies are treated with the processes shown in FIG. 2 correspondingly, thereby yielding three sample groups of magnesium alloy articles. As shown in FIG. 3, solutions (A column, B column, and C column) of acid pickling solutions, alkaline solutions, and phosphate solutions are used during the corresponding processes for the three sample groups (1^{st} group, 2^{nd} group, and 3^{rd} group) of magnesium alloy main bodies.

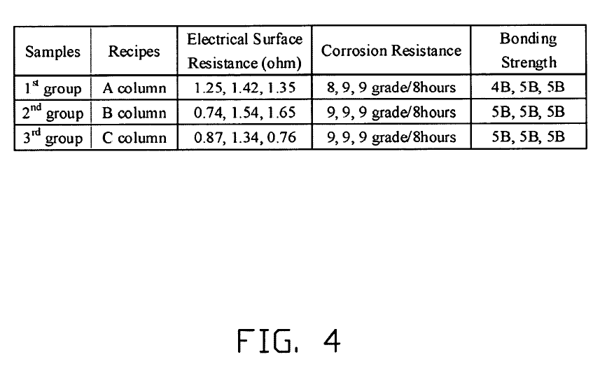

Corrosion resistances of the samples are evaluated using a salt spray tester. A salt spray test solution used in the salt spray tester included 5% sodium chloride (NaCl). Electrical surface resistances of the samples of the magnesium alloy articles were evaluated using a micro-ohmmeter. Bonding strength of the samples of the magnesium alloy articles was evaluated with a cross-cut test after the paint coating was formed over the phosphate film. In FIG. 4, test results of the samples are shown. Corrosion resistance of the samples of the magnesium alloy articles all exceed grade 8, the electrical surface resistances of samples of the magnesium alloy articles are all less than 2 ohms, and bonding strengths of the samples of the magnesium alloy articles all exceed 3B. The test result shows that the magnesium alloy articles all have good corrosion resistance, relatively high bonding strength, and low electrical surface resistance. It is understood that, if the magnesium alloy articles are applied to the portable electronic devices, the portable electronic devices will exhibit good electromagnetic interference shielding efficiency.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A method for fabricating a magnesium alloy article, comprising;
a magnesium alloy main body being provided;
the magnesium alloy main body being submerged in an acid pickling solution thereby removing oxides and release agents from the surface thereof;
the magnesium alloy main body being submerged in an alkaline solution thereby removing ash from the surface thereof; and
the magnesium alloy main body being submerged in a phosphate solution containing tannic acid thereby forming a phosphate film on the surface thereof.

2. The method as claimed in claim 1, wherein the method further comprises degreasing or sandblasting the magnesium alloy main body before submersion in the acid pickling solution.

3. The method as claimed in claim 1, wherein submersion of the magnesium alloy main body in the acid pickling solution lasts from 3 to 5 minutes, with temperature of the acid pickling solution from 35° C. to 45° C.

4. The method as claimed in claim 1, wherein submersion of the magnesium alloy main body in the phosphate solution lasts from 30 seconds to 50 seconds, with temperature of the phosphate solution from 35° C. to 45° C.

5. The method as claimed in claim 1, wherein the acid pickling solution comprises 5 to 30 g/l of citric acid and 1.5 to 6 g/l of surface active agent.

6. The method as claimed in claim 1, wherein the phosphate solution comprises 2.89 to 8.67 g/l of H₃PO₄, 0.3 to 1 g/l of (NH₂)₂CO, 0.39 to 1.56 g/l of HNO₃, 6 to 30 g/l of Mn(H₂PO₄)₂, and 0.2 to 0.6 g/l of tannic acid.

7. The method as claimed in claim 1, the method further comprises water rinse after submersion of the magnesium alloy main body in the acid pickling solution, alkaline solution, or phosphate solution.

8. A magnesium alloy article comprising a main body and a phosphate film formed on a surface thereof, wherein the phosphate film comprises carbon, oxygen, magnesium, aluminum, phosphorus, and manganese.

9. The magnesium alloy article as claimed in claim 8, wherein corrosion resistance of the phosphate film exceeds grade 8 in a salt spray test.

10. The magnesium alloy article as claimed in claim 8, wherein an electrical surface resistance is less than 2 ohms.
